(19) United States
(12) Patent Application Publication
(10) Pub. No.: US 2010/0183888 A1
(43) Pub. Date: Jul. 22, 2010

(54) ACCESSORY COATING COMPOSITION HAVING FRAGRANCE EMISSION FUNCTION

(76) Inventor: Young-Nam RHEE, Seoul (KR)

Correspondence Address: PARK LAW FIRM, 3255 WILSHIRE BLVD, SUITE 1110, LOS ANGELES, CA, 90010, US

(21) Appl. No.: 12/391,192

(22) Filed: Feb. 23, 2009

(30) Foreign Application Priority Data
Jan. 22, 2009 (KR) 10-2009-0005472

(51) Int. Cl. B32B 15/04; B32B 9/04; B32B 29/00

(52) U.S. Cl. 428/457; 428/704; 428/696; 428/532

(57) ABSTRACT

An accessory coating composition having a fragrance emission function is disclosed, in which a fragrance composition containing 10-hexaoxa decanolide, 11-hexaoxa decanolide or 12-hexaoxa decanolide, nicotinic acid amide and fragrance is coated on the surfaces of various accessories, so the fragrance composition-coated accessories can continuously emit fragrance for a long time.

### BACKGROUND OF INVENTION

1. Technical Field

The present invention relates to an accessory coating composition having a fragrance emission function, and in particular to an accessory coating composition having a fragrance emission function, which contains 10-hexaoxa decanolide, 11-hexaoxa decanolide or 12-hexaoxa decanolide, nicotinic acid amide and fragrance.

2. Background Art

As various fashion cultures are advanced and spread, a human clothes and accessories used in many portions of a human body are diversified. Designs and colors of such accessories fast change.

The accessories might be classified into a necklace, an earring, a bracelet or something. The above accessories are generally decorated by means of an artificial pearl or other artificial gemstone.

For example, a natural pearl has a natural color and arrogance, which it can be used as a high-end accessory item and is expensive due to scarcity and a difficult process. A careful handing and wearing are needed, and a user worries about robbery.

So as to overcome the above inconveniences and problems, an artificial pearl is being manufactured using a synthetic material. A certain material is coated on an artificial pearl for thereby manufacturing a natural pearl-like artificial pearl, which is finally used as various accessories.

In view of a customer, an artificial pearl can be easily purchased due to its low price and an outstanding appearance like a natural pearl. Since it has a reliable durability and various sizes and designs, its selection and application increases.

The Korean patent registration number 586152 “Coating method of thermoplastic resin beads for artificial pearl” invented by the same applicant as the present invention, the Korean patent registration number 601154 “Coating composition of artificial pearl” invented by the same applicant as the present invention, and the U.S. Pat. No. 6,890,379 “Coating composition of artificial pearl” are known as prior art. In the above prior art, an artificial pearl coating composition and method, which does not contain lead component, is disclosed for producing an artificial pearl having a natural pearl-like color and arrogance.

However, the artificial pearl produced from the above prior art has features like the natural pearl, but does not have a fragrance emission function. As the use of fragrance increased days and days along with the development of industry and life standard, a lot of people directly spray fragrance on clothes and skins using a liquid fragrance.

So as to enhance a fragrance emission function and volatility, a fragrance raw source is mixed with a high purity alcohol. In this case, a fragrance emission effect can be enhanced with the helps of the volatility of alcohol, but a fragrance duration time is very short, for example, a couple hours.

When a liquid fragrance is spread to clothes, if its amount is a lot, a user might feel wet while leaving stains. In addition, since fragrance duration time is very short, it is needed to use every time. When a user wears various accessories including an artificial pearl whose surface is coated with a chemical paint, a certain user, who suffers from a particular disease, might have a skin trouble or itchy or spot. The problems with a skin are known to occur due to a lack of a specific vitamin and an allergy reaction.

The composition for coating an artificial pearl has advanced in its technology and has reached a natural pearl-like pearl having an excellent color and touching feeling without lead composition. As the coating time and dry time decrease, the productivity is significantly enhanced.

Since the paints disclosed in the prior art is mainly made of a chemical, it is impossible to substantially remove a specific smell from a chemical used like other paints.

The smell from the paints does not affect a human body, but a working environment might be worsened due to the above smell.

The workers, who fail to tolerate the above smell, cannot increase the workability. Though a lot of efforts have been given so as to decrease a specific smell of paint, but the problems still remain unsolved.

### DETAILED DESCRIPTION OF EMBODIMENTS OF INVENTION

### Disclosure of the Invention

Accordingly, it is an object of the present invention to provide an accessory coating composition having a fragrance emission function which is coated on the surface of various accessories for thereby continuously emitting fragrance during a long time from the accessories.

To achieve the above objects, there is provided an accessory coating composition comprising a primary coat composition, an intermediate coat composition and a top coat composition, and said primary, intermediate and top coat compositions including a fragrance composition containing:

a) 10-hexaoxa decanolide, 11-hexaoxa decanolide or 12-hexaoxa decanolide;

b) nicotinic acid amide; and

c) a fragrance.

To achieve the above objects, there is provided an accessory coated with the above-disclosed composition.

The above accessory is an artificial pearl.

### Effects

The accessory coating composition having a fragrance emission function according to the present invention can continue to emit fragrance by coating the composition of the present invention on the surface of various accessories with the helps of fragrance emission functions.

In addition, since various fragrances can be contained depending on a user's preference, an additional fragrance is not needed, and even in a storing state, fragrance can be emitted along with its easier handling.

When coating an accessory coating composition of the present invention, since a chemical smell can significantly decrease as compared to a conventional coating composition, workability can be enhanced, and a work environment can be significantly improved in the present invention.

### Modes for Carrying out the Invention

The preferred embodiments according to the present invention will be described as follows.

The accessory coating composition according to the present invention comprises a primary coat composition, an intermediate coat composition and a top coat composition. The primary, intermediate and top coat compositions include a fragrance composition containing 10-hexaoxa decanolide, 11-hexaoxa decanolide or 12-hexaoxa decanolide and a fragrance.

The fragrance composition contains 10-hexaoxa decanolide, 11-hexaoxa decanolide or 12-hexaoxa decanolide, nicotinic acid amide and fragrance.

The 10-hexaoxa decanolide, 11-hexaoxa decanolide or 12-hexaoxa decanolide are a couple representatives of a synthesized compound fragrance having a fragrance similar with artificial musk collected from musk deer. When is mixed with other fragrances, a high-end fragrance is produced. It has a fragrance function, a fragrance over emission prevention function, and fragrance purification and smoothing function.

Ethylenebrasylate, decanone, cyclopenta decanolide, ambrette etc. might be used instead 10-hexaoxa decanolide, 11-hexaoxa decanolide or 12-hexaoxa decanolide contained in the fragrance composition of the accessory coating composition according to the present invention.

The 10-hexaoxa decanolide, 11-hexaoxa decanolide or 12-hexaoxa decanolide is preferably contained in the fragrance composition by 1 through 25 weight %. When the amount is in the above range, an over fragrance prevention function, a purification function and a smoothing function are optimized.

The nicotinic acid amide is a component of vitamin B group and has a trouble prevention function by means of fragrance continuity, fragrance maintenance and skin stability and an allergy and skin spot prevention effect.

Here, the nicotinic acid amide is contained in a fragrance composition preferably by 5 through 35 weight %. When the amount is in the above range, an inherent effect of the nicotinic acid amide can be maximized.

The fragrance is a raw liquid of common fragrance mixed in a fragrance or fragrance composition, which is harmless to human body and is selected unless it does not affect the functions of 10-hexaoxa decanolide, 11-hexaoxa decanolide or 12-hexaoxa decanolide and nicotinic acid amide. The fragrance can be properly selected depending on a user's preference and trend who uses an accessory according to the present invention.

The above fragrance can be used in a liquid form or can be used by diluting the same by 40 through 60%. In details, the fragrance might be selected from the group consisting of menthol, menthone, camphor, pulegol, isopulegol, cineol, mint oil, peppermint oil, spearmint oil, eucalyptus oil, 3-1-menthoxypropane-1,2 diol, N-alkyl-p-menthane-3-carboxamide, 3-1-menthoxy-2-methylpropane-1,2-diol, p-menthane-3,8-diol, 2-1-menthoxyethane-1-ol, 3-1-menthoxy propane-1-ol, 4-1-menthoxy butane-1-ol, menthyl 3-hydroxy butanoate, menthyl ractate, menthone glycerine ketal, 2-(2-1-menthyloxyethyl)ethanol, menthyl glyoxylate, N-methyl-2,2-isoprophylmethyl-3-methylbutaneamide, menthyl-2-pyrrolidone-5-carboxylate, monomenthyl succinate, alkali metal salt of monomenthyl succinate, alkali earth metal salt of monomenthyl succinate, monomenthyl glutarate, alkali metal sale of monomenthyl glutarate, alkali earth metal salt of monomenthyl glutarate, N-[[5-methylethyl]-cyclohexyl]carbonyl]glycine, p-menthane-3-carboxylic acid glycerol ester, menthol propylene glycol carbonate, menthol ethylene glycol carbonate, 6-isopropyl-3,9-dimethyl-1,4-dioxaspiro[4,5]decan-2-on(6-isopropyl-3,9-dimethyl-1,4-dioxaspiro[4,5]ecan-2-one).

The fragrance is contained in the fragrance composition preferably by 40 through 94 weight %. When the amount is in the above range, various fragrances might be produced from the accessory according to the present invention.

The fragrance composition containing 10-hexaoxa decanolide, 11-hexaoxa decanolide or 12-hexaoxa decanolide, nicotinic acid amide and fragrance according to the present invention might be contained in a primary coat composition, an intermediate coat composition and a top coat composition of the accessory coating composition of the present invention. Here, the fragrance composition might be contained into the primary, intermediate and top coat compositions by changing the adding amount of the same. In more detail, the adding amount is decreased by about 30% in such a manner that the fragrance composition added to the intermediate coat composition decreases more as compared to the fragrance composition added to the primary coat composition, and the fragrance composition added to the top coat composition decreases more as compared to the fragrance composition added to the intermediate coat composition.

The decrease of the adding amount of the fragrance composition is performed for the following reasons. Namely, the adding amount of the fragrance composition for a primary coat composition, which forms the most inner side of an accessory, is most, and the coating layer of the intermediate coat composition is coated thereon, and the coating layer of the intermediate coat composition whose adding amount is less than the primary coat composition is surrounded by means of the top coat composition whose adding amount is least, for thereby inhibiting the emission of fragrance. In addition, a fragrance maintenance function, an over fragrance emission prevention function by means of a fragrance smoothing agent, and a fragrance purification function, which are obtained with the helps of 10-hexaoxa decanolide, 11-hexaoxa decanolide or 12-hexaoxa decanolide, nicotinic acid amide and fragrance added to the fragrance composition of the present invention, are obtained, and a fragrance duration time is elongated. In addition, it is possible to keep an epithelium tissue healthy by enhancing a fragrance duration time and a fragrance maintenance function and preventing a skin trouble with the helps of nicotinic acid amide which has a long fragrance duration time, a fragrance maintenance function and a skin trouble prevention.

The primary coat composition, intermediate coat composition and top coat composition, which contain the above fragrance composition, consist of the following components, respectively.

The primary coat composition contains 1 through 90 weight % of a fragrance composition with respect to 100 weight % of the composition which contains 20 through 85 weight % of ethyl acetate, 13 through 55 weight % of butyl acetate, 1 through 10 weight % of celluloid, 0.2 through 5 weight % of camphor and 0.5 through 10 weight % of pearl paint.

The intermediate coat composition contains 1 through 60 weight % of a fragrance composition with respect to 100 weight % of the composition which contains 15 through 40 weight % of ethyl acetate, 13 through 60 weight % of butyl acetate, 1 through 10 weight % of celluloid, 0.2 through 5 weight % of camphor and 0.5 through 10 weight % of pearl paint.

The top coat composition contains 1 through 30 weight % of a fragrance composition with respect to 100 weight % of the composition which contains 10 through 30 weight % of ethyl acetate, 25 through 70 weight % of butyl acetate, 1 through 10 weight % of celluloid, 0.2 through 5 weight % of camphor and 0.5 through 10 weight % of pearl paint.

The primary, intermediate and top coat compositions, which are mixed at the above ratios, are adapted with the same mixing method, and since alcohol contained in the fragrance composition does not dissolve celluloid, it is preferably needed to mix along with a fragrance composition when mixing ethyl acetate and butyl acetate. Namely, when mixing the compositions, it is preferred that ethyl acetate and butyl acetate and fragrance composition are first mixed, and celluloid is added and dissolved, and then a pearl paint is mixed in the transparent coating state for thereby finishing the composition.

The pearl paint contained in the primary, intermediate and top coat compositions is formed of a liquid pearl paint containing bismuthoxychloride as a main component, so it is possible to obtain a color and luster similar with a natural pearl. Since the liquid pearl paint containing bismuthoxychloride as a main component is expensive, which leads to increasing a manufacture unit cost. So, it might be partially substituted with titanium dioxide-coated mica, and a liquid pearl paint containing bismuthoxychloride as a main component and titanium dioxide-coated mica might be mixed at a certain ratio. Here, it is preferred that the mixing ratio between a liquid pearl paint, which contains bismuthoxychloride as a main component, and titanium dioxide-coated mica is 10:90 through 40:60 in their weight %.

The pearl paint might be formed of brass powder, aluminum powder, copper powder or something, which are nonferrous metals. When the nonferrous metals are used as a pearl paint, it is possible to obtain an inherent color of nonferrous metals while avoiding a simple pearl color. In particular, it is preferred that the nonferrous metal powder paints are separately used from one another, and it is preferred that the mixing ratios of the same are same as the mixing ratios of the pearl paints mixed in the primary, intermediate and top coat compositions.

It is preferred that the fragrance compositions added to the primary, intermediate and top coat compositions can change in their adding amount, and it is preferred that the amount of the fragrance composition added to the primary, intermediate and top coat compositions is gradually decreased by about 30%.

As a result of the long time experiment, the mixing amount of the fragrance composition, which is least in the adding compositions, is less by about 60% as compared to the primary coat composition, and is less by about 30% as compared to the intermediate coat composition, the fragrance emission range and concentration are almost same as when a common fragrance is used. When a surface is coated with an intermediate coat composition, the fragrance emission range is too broad, and the concentration of fragrance is too intensive, and when the surface is coated with a primary coat composition, the fragrance emission range is further too broad, and the concentration of the fragrance is so intensive, so they are not preferred.

The present invention provides an accessory coated with the above primary, intermediate and top coat compositions. The above accessory is preferably an artificial pearl.

The method for coating the surface of an accessory using a primary, intermediate and top coat composition will be described. First, an accessory is retted in a primary coat composition for a first coating process, and it is dried at a room temperature (18 through 25° C.) for about 20 through 30 minutes (a recoating is possible). The first coated accessory is retted in an intermediate coat composition for a second coating process, and is dried at a room temperature (18 through 25° C.) for about 20 through 3 minutes (a recoating is possible). The second coated accessory is retted in a top coat composition for a third coating process, and is dried at a room temperature (18 through 25° C.) for about 20 through 30 minutes for thereby finishing a coating process of a certain accessory.

At this time, when the drying process is performed at a room temperature of 18 through 25° C., the drying time is longer as compared to an artificial drying process (at 4 through 5° C.). However, since a fragrance component is weak to heat, it is preferred to dry at a room temperature.

It is preferred that the coating processes are sequentially performed using the primary, intermediate and top coat compositions in the course of coating, but the coating process might be performed twice using a primary coat composition, and then the coating might be performed one time using a top coat composition. In another embodiment of the present invention, the coating might be performed two times using an intermediate coat composition, and then it is performed once using a top coat composition.

However, when an accessory is made by coating a primary coat composition one through three times, it is not preferred because a fragrance emission concentration is too high. When an accessory is made by coating an intermediate coat composition one through three times, a fragrance emission concentration is relatively high. When an accessory is made by coating a top coat composition one to three times, a fragrance emission concentration is proper but a fragrance duration time decreases.

The accessories coated using an accessory coating composition according to the present invention has a fragrance emission effect of about three through six months, which might change depending on a surrounding temperature and a storing condition.

The following embodiments of the present invention are given for better understanding the present invention, and the scopes of the present invention are not limited by means of the disclosed embodiments.

### Embodiments

### Preparation 1. Fragrance Composition Preparation

A fragrance composition was prepared as 65 weight % of eucalyptus oil containing 25 weight % of 10- or 11- or 12-hexaoxa decanolide, 20 weight % of nicotinic acid amide and 40 through 60 weight % of alcohol was inputted in a container and was mixed and agitated.

### First Embodiment: Coating Composition Preparation

An primary coat composition was prepared as 90 weight % of a fragrance composition prepared in the preparation 1 was mixed with 100 weight % of a mixture mixed with 10 weight % of a liquid pearl paint formed of 56 weight % of ethyl acetate, 28.5 weight % of butyl acetate, 5 weight % of celluloid, 0.5 weight % of camphor and bismuthoxychloride which were added as main components.

An intermediate coat composition was prepared as 60 weight % of a fragrance composition prepared in the preparation 1 was mixed with 100 weight % of a mixture mixed with 5.71 weight % of a liquid pearl paint formed of 40.8 weight % of ethyl acetate, 48.9 weight % of butyl acetate, 4.1 weight % of celluloid, 0.49 weight % of camphor and bismuthoxychloride which were added as main components.

A top coat composition was prepared as 30 weight % of a fragrance composition prepared in the preparation 1 was mixed with 100 weight % of a mixture mixed with 4.1 weight % of a liquid pearl paint formed of 25 weight % of ethyl acetate, 66.3 weight % of butyl acetate, 4.1 weight % of celluloid, 0.5 weight % of camphor and bismuthoxychloride which were added as main components.

### Second Embodiment: Coating Composition Preparation

The second embodiment was the same as the first embodiment of the present invention except that a paint mixed at a ratio of 50:50 between a liquid pearl paint and titanium dioxide-coated mica, which liquid pearl paint was formed of bismuthoxychloride as a main component instead a liquid pearl paint containing bismuthoxychloride as a main component in the course of preparing the primary, intermediate and top coat compositions of the first embodiment.

### Third Embodiment: Coating Composition Preparation

The third embodiment was the same as the first embodiment of the present invention except that a brass powder was used instead a liquid pearl paint containing bismuthoxychloride as a main component in the course of preparing the primary, intermediate and top coat compositions of the first embodiment.

### First Comparison: Coating Composition Preparation

The preparation was the same as the method of the first embodiment except that a fragrance composition was not used in the course of preparing the primary, intermediate and top coat composition of the first embodiment of the present invention.

As a result of the lead component detection experiment with respect to the primary, intermediate and top coat compositions prepared in the first through third embodiments of the present invention, 0% of lead components were contained in all the compositions.

The coating compositions prepared in the first through third embodiments and first comparison according to the present invention are coated on the artificial pearls as follows.

First, an accessory is retted in a primary coat composition for a first coating process, and it is dried at a room temperature (18 through 25° C.) for about 20 through 30 minutes. The artificial pearl was retted in an intermediate coat composition for a second coating process, and was dried at a room temperature (18 through 25° C.) for about 20 through 3 minutes. The artificial pearl was retted in a top coat composition for a third coating process, and was dried at a room temperature (18 through 25° C.) for about 20 through 30 minutes for thereby finishing a coating process.

A necklace was prepared using an artificial pearl coated with the coating compositions, respectively, prepared in the first through third embodiments and first comparison of the present invention. In addition, the neck laces were given to 30 adult women in their 20 through 40's ages for wearing for evaluating the fragrance emission and concentration. A result of the above experiment is shown in the following table 1. The evaluation is made with 5 points. The point 5 means excellent, 4 means better, 3 means common, 2 means worse, and 1 means worst.

TABLE 1

| | Embodi- | | Embodi- | |
|---|---|---|---|---|
| | ment 1 | Embodiment 2 | ment 3 | Comparison 1 |
| Fragrance | 4.7 | 4.6 | 4.7 | 2 |
| emission | | | | |
| Fragrance | 4.8 | 4.7 | 4.8 | 1 |
| concentration | | | | |
| Total | 4.6 | 4.7 | 4.7 | 3 |
| preferences | | | | |

As seen in the above table 1, in case that an artificial pearl is coated using a coating composition containing a fragrance composition according to the present invention, it is known that the fragrance emission and concentration and preferences are excellent.

As a result of the experiment of a fragrance emission and concentration while storing an artificial pearl coated with a coating composition prepared in the first through third embodiments and first comparison of the present invention at a room temperature for eight months, an artificial pearl kept emitting up to six months after storing, and the fragrance concentration was decreased as time passed. No fragrance was emitted after six months. As a result of the above experiments, it is known that the fragrance emission kept for about six months when coating a certain accessory with a coating composition of the present invention.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

What is claimed is:

1. An accessory coating composition, comprising:
a primary coat composition, an intermediate coat composition and a top coat composition, and said primary, intermediate and top coat compositions including a fragrance composition containing:
a) 10-hexaoxa decanolide, 11-hexaoxa decanolide or 12-hexaoxa decanolide;
b) nicotinic acid amide; and
c) a fragrance.

2. The composition of claim 1, wherein said fragrance composition contains:
a) 1 through 25 weight % of 10-hexaoxa decanolide, 11-hexaoxa decanolide or 12-hexaoxa decanolide;
b) 5 through 35 weight % of nicotinic acid amide; and
c) 40 through 94 weight % of a fragrance.

3. The composition of claim 1, wherein said composition contains at least one component selected from the group consisting of ethylenebrasylate, decanone, cyclopenta decanolide and ambrette instead 10-hexaoxa decanolide, 11-hexaoxa decanolide or 12-hexaoxa decanolide.

4. The composition of claim 1, wherein said fragrance is formed of at least one component selected from the group consisting of menthol, menthone, camphor, pulegol, isopulegol, cineol, mint oil, peppermint oil, spearmint oil, eucalyptus oil, 3-1-menthoxypropane-1,2 diol, N-alkyl-p-menthane-3-carboxamide, 3-1-menthoxy-2-methylpropane-1,2-diol, p-menthane-3,8-diol, 2-1-menthoxyethane-1-ol, 3-1-menthoxy propane-1-ol, 4-1-menthoxy butane-1-ol, menthyl 3-hydroxy butanoate, menthyl ractate, menthone glycerine ketal, 2-(2-1-menthyloxyethyl)ethanol, menthyl glyoxylate, N-methyl-2,2-isoprophylmethyl-3-methylbutaneamide, menthyl-2-pyrrolidone-5-carboxylate, monomenthyl succinate, alkali metal salt of monomenthyl succinate, alkali earth metal salt of monomenthyl succinate, monomenthyl glutarate, alkali metal sale of monomenthyl glutarate, alkali earth metal salt of monomenthyl glutarate, N-[[5-methylethyl]-cyclohexyl]carbonyl]glycine, p-menthane-3-carboxylic acid glycerol ester, menthol propylene glycol carbonate, menthol ethylene glycol carbonate, 6-isopropyl-3,9-dimethyl-1,4-dioxaspiro[4,5]decan-2-on(6-isopropyl-3,9-dimethyl-1,4-dioxaspiro[4,5]ecan-2-one).

5. The composition of claim 1, wherein said primary coat composition contains 1 through 90 weight % of a fragrance composition containing:
b)
i) 1 through 25 weight % of 10-hexaoxa decanolide, 11-hexaoxa decanolide or 12-hexaoxa decanolide;
ii) 5 through 35 weight % of nicotinic acid amide; and
iii) 40 through 94 weight % of a fragrance,
with respect to 100 weight % of a composition containing:
a)
i) 20 through 85 weight % of ethyl acetate;
ii) 13 through 55 weight % of butyl acetate;
iii) 1 through 10 weight % of celluloid;
ix) 0.2 through 5 weight % of camphor; and
v) 0.5 through 10 weight % of a pearl paint.

6. The composition of claim 5, wherein said pearl paint is a liquid pearl paint containing bismuthoxychloride as a main component.

7. The composition of claim 5, wherein said pearl paint is a mixture of a liquid pearl paint containing bismuthoxychloride as a main component and titanium dioxide-coated mica.

8. The composition of claim 7, wherein said liquid pearl paint containing bismuthoxychloride as a main component and said titanium dioxide-coated mica are mixed at a ratio of 10:90 through 40:60.

9. The composition of claim 5, wherein said pearl paint is formed of at least one selected from brass powder, aluminum powder and copper powder.

10. The composition of claim 1, wherein said intermediate coat composition contains 1 through 60 weight % of a fragrance composition containing:
b)
i) 1 through 25 weight % of 10-hexaoxa decanolide, 11-hexaoxa decanolide or 12-hexaoxa decanolide;
ii) 5 through 35 weight % of nicotinic acid amide; and
iii) 40 through 94 weight % of a fragrance,
with respect to 100 weight % of a composition containing:
a)
i) 15 through 40 weight % of ethyl acetate;
ii) 13 through 60 weight % of butyl acetate;
iii) 1 through 10 weight % of celluloid;
ix) 0.2 through 5 weight % of camphor; and
v) 0.5 through 10 weight % of a pearl paint.

11. The composition of claim 10, wherein said pearl paint is a liquid pearl paint containing bismuthoxychloride as a main component.

12. The composition of claim 10, wherein said pearl paint is a mixture of a liquid pearl paint containing bismuthoxychloride as a main component and titanium dioxide-coated mica.

13. The composition of claim 12, wherein said liquid pearl paint containing bismuthoxychloride as a main component and said titanium dioxide-coated mica are mixed at a ratio of 10:90 through 40:60.

14. The composition of claim 10, wherein said pearl paint is formed of at least one selected from brass powder, aluminum powder and copper powder.

15. The composition of claim 1, wherein said top coat composition contains 1 through 30 weight % of a fragrance composition containing:
b)
i) 1 through 25 weight % of 10-hexaoxa decanolide, 11-hexaoxa decanolide or 12-hexaoxa decanolide;
ii) 5 through 35 weight % of nicotinic acid amide; and
iii) 40 through 94 weight % of a fragrance,
with respect to 100 weight % of a composition containing:
a)
i) 10 through 30 weight % of ethyl acetate;
ii) 25 through 70 weight % of butyl acetate;
iii) 1 through 10 weight % of celluloid;
ix) 0.2 through 5 weight % of camphor; and
v) 0.5 through 10 weight % of a pearl paint.

16. The composition of claim 15, wherein said pearl paint is a liquid pearl paint containing bismuthoxychloride as a main component.

17. The composition of claim 15, wherein said pearl paint is a mixture of a liquid pearl paint containing bismuthoxychloride as a main component and titanium dioxide-coated mica.

18. The composition of claim 17, wherein said liquid pearl paint containing bismuthoxychloride as a main component and said titanium dioxide-coated mica are mixed at a ratio of 10:90 through 40:60.

19. The composition of claim 15, wherein said pearl paint is formed of at least one selected from brass powder, aluminum powder and copper powder.

20. An accessory characterized in that it is coated with a composition of claim 1.

21. The accessory of claim 20, wherein said accessory is an artificial pearl.
